(19) United States
(12) Patent Application Publication
(10) Pub. No.: US 2013/0095280 A1
(43) Pub. Date: Apr. 18, 2013

(54) REMOVABLE COVER FOR A BICYCLE SADDLE

(71) Applicant: Barbara Bigolin, Asolo (Treviso) (IT)

(72) Inventor: Barbara Bigolin, Asolo (Treviso) (IT)

(73) Assignee: Selle Royale S.p.A., Pozzoleone (Vicenza ) (IT)

(21) Appl. No.: 13/805,819

(22) PCT Filed: Apr. 6, 2011
(86) PCT No.: PCT/IB2011/051490

§ 371 Date: Dec. 20, 2012

(30) Foreign Application Priority Data
Jun. 22, 2010 (IT) VR2010A000126

(51) Int. Cl. B62J 1/20; A43B 23/00; A47C 7/62

(52) U.S. Cl. CPC B62J 1/20; A47C 7/62; A43B 23/00
USPC 428/100; 297/219.11; 297/219.1; 36/72 R; 428/99; 150/154

(57) ABSTRACT

Removable protection for a support structure for the human body, the support structure having a rear portion, a front portion, a side portion and elements of said support structure including a covering element to be applied on the rear portion and/or on the front portion and/or on the side portion of the support structure, the covering element having one or more extensions for fastening the covering element to the elements of the support structure and/or to the support structure itself, wherein the covering element has suitable dimensions for covering at least a portion of the rear portion and/or of the front portion and/or of the side portion and such a flexibility as to adjust to the shape of the same.

### TECHNICAL FIELD OF THE INVENTION

The present invention relates to a removable protection for a support structure for the human body, like for example a saddle for a bicycle or for similar vehicles, in particular for a saddle of a mountain bike, a seat, footwear, etcetera.

### DESCRIPTION OF RELATED ART

During ordinary use, the known saddles for bicycles are subject to friction, rubbing and scratches that lead to the wear and consequent deterioration thereof. This problem is particularly felt in the field of sport bicycles, where wear tends to be stronger, due to both the contact of the saddle surface with natural objects (such as trees, branches, sand and rocks) and to the use of specific equipment in some disciplines such as the “downhill” (as safety elements for the biker). Moreover, in these situations, falls and shocks are more frequent. Patent application WO9957004, for example, describes a bicycle saddle structure with a wear-proof layer of an elastically yielding material that projects from the side surface of a covering layer in order to the side surface of a covering layer in order to prevent the direct contact of the saddle with the outer abrasive surfaces. A pair of wear-proof layers projecting from the side surface of the saddle is located in substantially symmetrical positions relative to the longitudinal axis of the same, in the maximum cross section area of the saddle.

Moreover, further protections for the saddle surface are known, like the one described above, made of very resistant materials, more resistant than the usual microfiber fabric, such as “Meryl Techno” or an equivalent polyamide with a higher abrasion and tearing resistance. However, this type of material makes the manual assembly of the saddle difficult and slows down the production of the same. The main difficulty is caused by the larger thickness of the material, which makes it more difficult to bend, glue and above all makes more difficult to remove any creases during the gluing of the same to the saddle shell. Moreover, it should be noted that the assembly of the covering layer to the shell is a totally manual process and therefore, the stronger and the thicker the material, the more difficult the installation thereof.

### SUMMARY OF INVENTION

An object of the present invention is to eliminate the above-mentioned conventional problems and drawbacks and provide an additional removable protection for a support structure for the human body, such as a saddle for a bicycle or for other similar vehicles, a seat, footwear, etcetera, so as to prevent and/or eliminate scratches/abrasions on the surface layer thereof.

Another object of the present invention is to make the protection removable and replaceable in case of wear, or totally customisable by the manufacturer or the user, in order to combine the colours of the various components of the support structure for the human body and/or offer different colours on the market.

A further object of the present invention is to provide a removable protection for an intuitive and easy use.

According to an aspect of the present invention, these objects are achieved by a protection for a support structure, such as for example a saddle and/or a seat and/or footwear, as specified in the present application.

The present application describes preferred and advantageous embodiments of the invention.

### BRIEF DESCRIPTION OF THE DRAWINGS

Further features and advantages of the invention will appear more clearly from the detailed description of a removable protection for a support structure, such as for example a saddle and/or a seat and/or footwear, illustrated by way of an example in the annexed drawings, wherein:

FIG. 1 is a top perspective view of a support structure for the human body whereon the removable protection according to the present invention is arranged;

FIG. 2 is a bottom perspective view of a support structure for the human body whereon the removable protection of FIG. 1 is arranged;

FIG. 3 is a side view of the removable protection according to the present invention;

FIG. 4 is a bottom view of the removable protection of FIG. 3;

FIG. 5 is a three-dimensional view of a bracket associated to the removable protection according to the present invention;

FIG. 6 is another three-dimensional view of the bracket of FIG. 5;

FIG. 7 is a side view of an alternative embodiment of the support structure whereon the removable protection according to the present invention is arranged;

FIG. 8 is a side view of yet another alternative embodiment of the support structure wherein the removable protection according to the present invention is arranged; and

FIG. 9 is a side view of a further embodiment of the support structure wherein the removable protection according to the present invention is arranged.

### DETAILED DESCRIPTION OF EMBODIMENTS OF THE INVENTION

In order to achieve the above objects, the invention describes a removable protection for a support structure for the human body, like for example a saddle for a bicycle or for other similar vehicles, and/or a seat and/or footwear, etcetera. The examples shown hereinafter, relating to a specific embodiment of a support structure, are only explicative and they do not limit the scope of protection of the present invention.

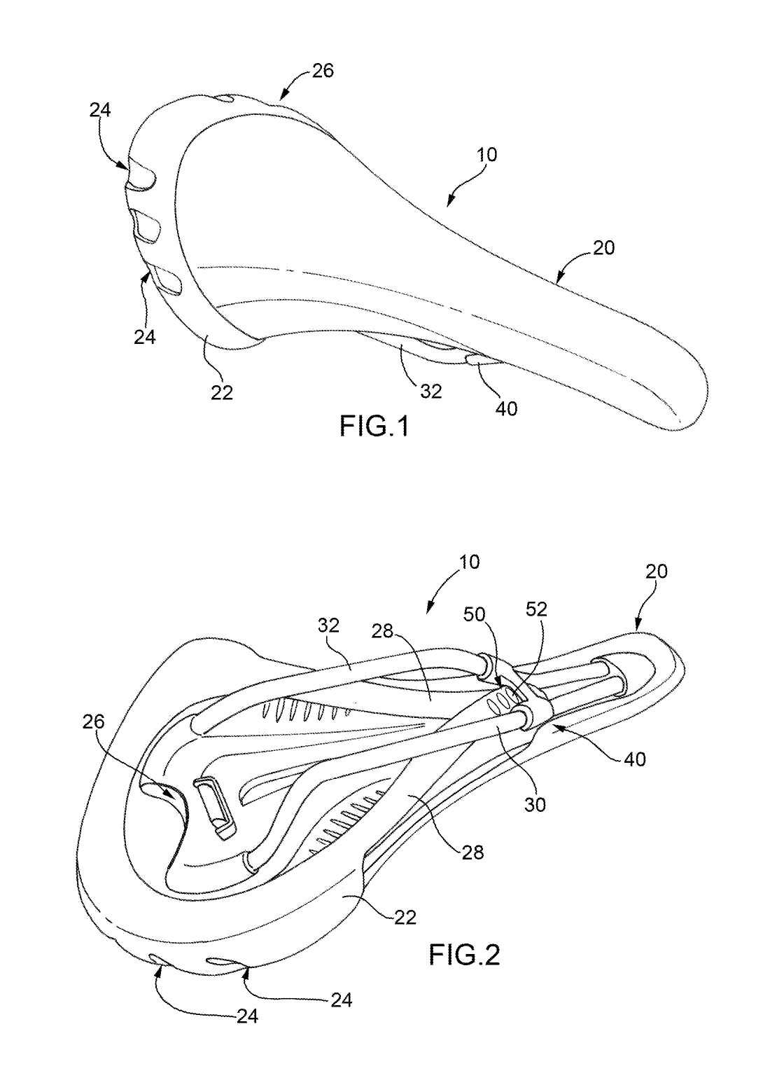

With reference to FIGS. 1-2, a bicycle saddle 10 is shown having an elongated front portion 20 and an enlarged rear portion 26 and provided with elements of the support structure, optionally shaped as two metal bars 30, 32. Advantageously, these two bars may be produced by a bar bent in the front portion thereof.

A covering element 22 is applied on the rear portion 26 that covers the rear edge of the same. Element 22 has surface openings 24 that allow seeing the underlying rear portion 26. The covering element 22 extends from one side to the other of the edge of the rear portion 26 forming a crown or cap covering thereon. In other words, element 22 surrounds the edge and/or the entire rear portion 26.

In particular, the removable protection has a cap or an open sleeve shape suitable for being applied on the rear portion 26 and/or in any other position.

Element 22 has one or more extensions 28, preferably elastic, that extend underneath saddle 10 and are capable of connecting to bars 30, 32, fixing element 22.

Such extensions 28 may be shaped as two bands provided with fastening means 50.

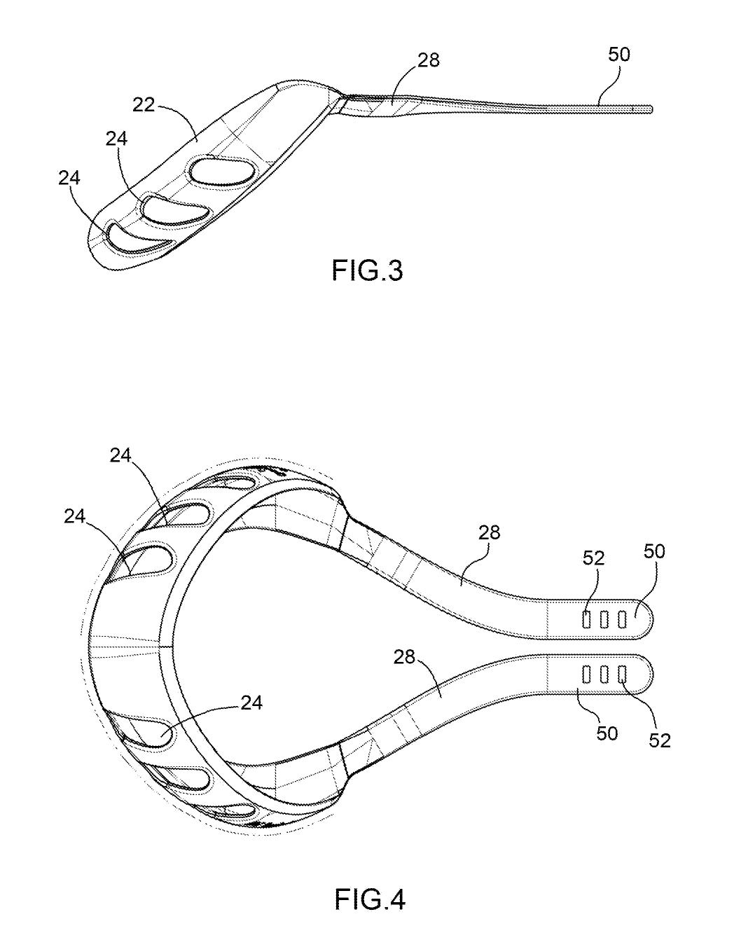

The fastening means, arranged at the end of extensions 28, may comprise a hook and/or, as shown in FIGS. 3 and 4, a central tongue provided with perforations 52.

The fastening means 50 may be fastened to a bracket 40, as shown in detail hereinafter.

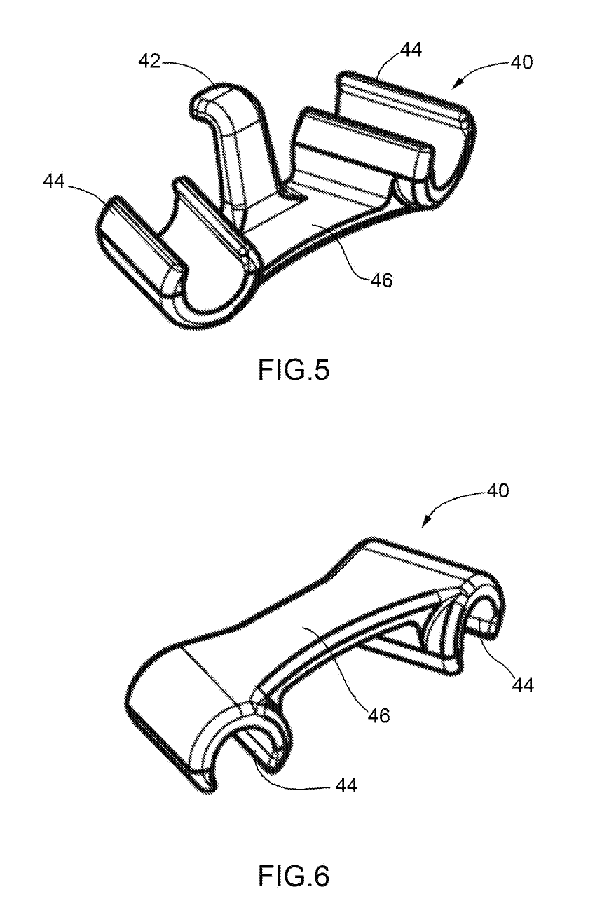

In order to mount element 22 onto saddle 10 it is sufficient to place and stretch it towards the rear portion 26 and/or front portion 20, preventing the forming of creases. Afterwards, extensions 28 and/or the fastening means 50 must be pulled towards the front portion 20 and/or towards the rear portion 26 of saddle 10, according to the positioning of the removable protection, until reaching a coupling element 42. In a preferred embodiment, the coupling element 42 is shaped as a curved tooth that extends from a bracket 40 fastened between bars 30, 32. Bracket 40, as shown in FIGS. 5 and 6, has a substantially symmetrical design and is provided with two semi cylindrical seats 44, in which bars 30, 32 may be inserted and received. The edges of the seats are made so as to allow bars 30, 32 to enter therein and then snap-lock them. Seats 44 are not parallel but they slightly converge towards one another, since normally bars 30, 32 converge towards the elongated portion 20 of saddle 10.

Seats 44 are connected by a base portion 46 wherefrom the coupling element 42 extends substantially orthogonal to the same.

The coupling means 50 may be pulled until the coupling element 42 inserts into a perforation 52 and the covering element 22 is well extended on the rear 26 and/or front 20 portion.

With reverse manoeuvres, element 22 may be quickly removed and easily replaced, if necessary. Therefore, it becomes a useful accessory for a saddle, capable of protecting the portions thereof that are more subject to wear, abrasion and shocks. The user may use this removable protection or not, according to the riding conditions. Moreover, element 22 can be completely customized by the manufacturer and the user.

Element 22 is preferably made of rubber or an equivalent material; moreover, different thickness and/or hardness, preferably 30-80 Shores, and/or mechanical resistances may be used in different portions of the same, which is for example made by co-moulding.

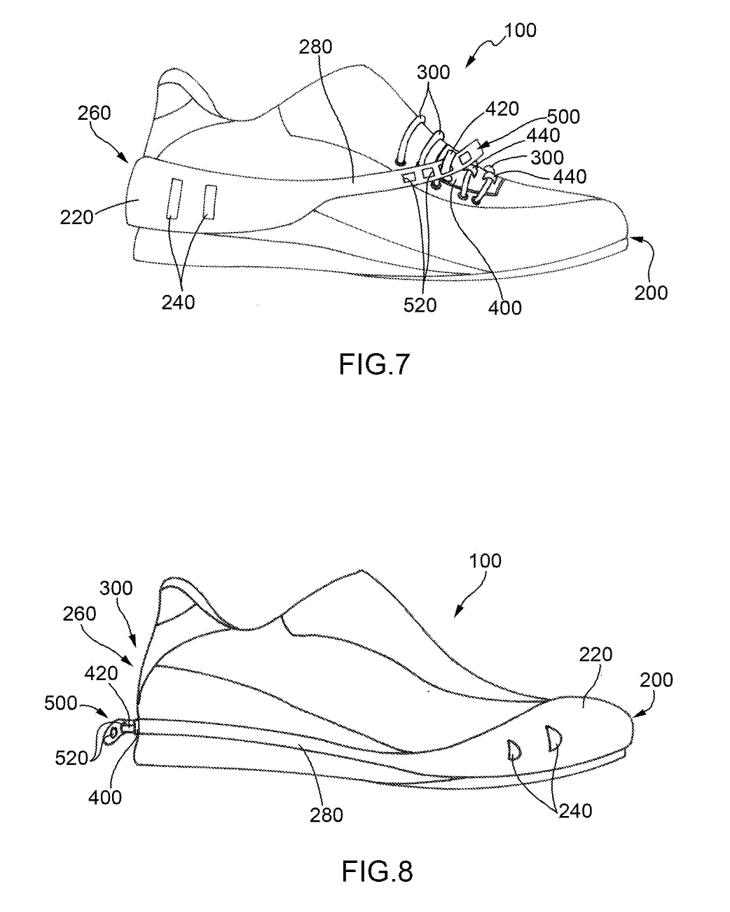

Element 22 may exhibit reinforcing members, also for example co-moulded, arranged on the exposed surface, or in any other position, so as to improve the abrasion resistance thereof, and/or in extensions 28, for forming fastening means to bars 30, 32. With reference to FIGS. 7-8, a shoe 100 having a front portion 200 and a rear portion 260 and provided with elements 300 of shoe 100, optionally in the form of a vamp, strings, string holes, etcetera, is shown. A covering element 220 is applied on the rear portion 260 and/or on the front portion 200 and/or on the side portion which protects one or more of such portions.

Element 220 has surface openings 240 that allow seeing the underlying shoe portion 100. The covering element 220 extends from one side to the other of the edge of the rear portion 260 and/or front portion 200 and/or side portion, forming a crown or cap covering thereon. In other words, element 220 surrounds the edge of the rear portion 260 and/or of the front portion 200 and/or of the side portion. For such purpose, the removable protection is shaped as a cap or as an open sleeve suitable for being applied on the relevant portion of shoe 100.

Element 220 has one or more extensions 280, preferably elastic, capable of connecting to one another by fixing element 220.

Such extensions 280 may be shaped as two bands provided with fastening means 500.

The fastening means 500 may be fastened to a bracket 400, as shown in detail hereinafter.

The fastening means 500, arranged at the end of extensions 280, may comprise a hook and/or a central tongue provided with perforations 520.

In order to mount element 220 onto shoe 100 it is sufficient to place and stretch it towards the rear portion 260 and/or front portion 200, preventing the forming of creases. Afterwards, extensions 280 and/or the fastening means 500 must be pulled towards the front portion 200 and/or towards the rear portion 260 of shoe 100, according to the positioning of the removable protection, until reaching a coupling element 420. In a preferred embodiment, the coupling element 420 exhibits the shape of a curved tooth or a protuberance or another device suitable for the purpose, which extends from a bracket 400 fastened to an element 300 of shoe 100. Bracket 400 is provided with engagement means 440 suitable for engaging with elements 300 of shoe 100.

The coupling element 420 projects from bracket 400 substantially orthogonal to the same.

The coupling means 500 may be pulled until the coupling element 420 inserts into a perforation 520 and the covering element 220 is well extended on the rear portion 260 and/or front portion 200 and/or side portion of shoe 100.

With reverse manoeuvres, element 220 may be quickly removed and easily replaced, if necessary. Therefore, it becomes a useful accessory for a shoe, capable of protecting the portions thereof that are more subject to wear, abrasion and shocks. The user may use this removable protection or not, according to the riding conditions. Moreover, element 220 can be completely customized by the manufacturer and the user.

Extensions 280 may be fastened, for example, at elements 300 such as the strings or the closing system of shoe 100 and/or at the rear portion 260 or front portion 200 thereof; the fastening may also occur at the side portions of shoe 100.

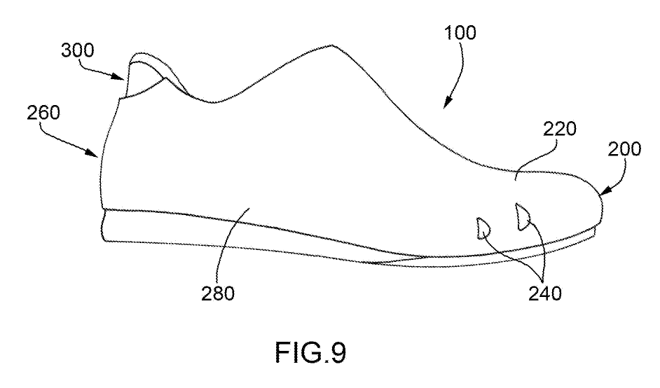

FIG. 9 shows a further embodiment of a shoe 100 that has a covering element 220, the extensions 280 of which extends towards the front portion with such a width as to form, along with the covering element 220 itself, a total covering of shoe 100. In this embodiment, extensions 280 may be fastened to each other or to elements 300 of shoe 100 through fastening means 500 and coupling means 420, so as to obtain the closing and fastening of the covering element 220 around the entire shoe 100. The fastening means 500 and the coupling means 420 may also be lacking and in this case the covering element 220, along with extensions 280 thereof, takes on a substantially continuous annular shape wherein such extensions 280 are connected and/or integral to one another, as shown in FIG. 9.

Therefore, the removable protection for a support structure 10, 100 for the human body comprises a covering element 22, 220 to be applied onto the rear portion 26, 260 and/or front portion 20, 200 and/or side portion of the support structure 10, 100.

Such covering element 22, 220 has one or more extensions 28, 280 suitable for fastening the covering element 22, 220 to the rear portion and/or front portion and/or side portion of the support structure 10, 100.

The removable protection and/or the covering element 22, 220 is shaped as a cap and has suitable dimensions for covering the edge portion of the rear 26, 260 and/or front 20, 200 and/or side portion of the support structure 10, 100 and such flexibility as to adjust to the shape of the same. In order to provide better resistance to wear, abrasion and shocks, the covering element 22, 220 is preferably made of a rubber or injected plastic material. However, other materials are possible for obtaining different elasticity and performance for meeting the requirements of different users.

It has been found that a good compromise between resistance and comfort is obtained if the rubber material exhibits a hardness of 30-80 Shores.

To improve the visual appearance and/or as a further degree of freedom in the shape thereof, the covering element 22, 220 may preferably have one or more through or not totally through surface openings, capable of leaving uncovered zones of the underlying support structure. Such openings do not affect the covering capacity of the protection, while exposing the underlying layer of the support surface 10, 100. Advantageously, the one or more extensions 28, 280 may be made integrally in the covering element 22, 220. This facilitates the production and reliability of the protection. Further reliability is obtained if the covering element 22, 220 has reinforcing members, for example co-moulded, in the visible surface or in any other position.

The removable protection may be effectively formed by the combination of a covering element from the ends thereof such extensions 28, 280 branch off. In order to facilitate the coupling of the removable protection with the support structure 10, 100, these extensions 28, 280 may end with fastening means 50, 500, optionally shaped as a tongue provided with perforations 52, 520 suitable for being fastened to a coupling element 42, 420 associated to the support structure 10, 100. An effective manner for obtaining the coupling element 42, 420 is to form it similar to a curved tooth optionally projecting from a bracket 40, 400 fastened on the rear portion or in a suitable position of the support structure 10, 100.

The fastening means 50, 500 and the coupling means 42, 420 may also be lacking and the closing and fixing of the covering element 22, 220 may take place through extensions 28, 280, which are connected to one another.

The removable protection according to the invention allows using the ordinary materials usually used in the covers for support structures for the human body, such as the traditional microfiber, while offering the desired protection to the user.

All problems relating to assembly are mostly solved using conventional materials for the covering of the support structure 10, 100, such as: greater easiness for distributing the creases or pleats in the rear portion of the support structure and/or in any other position after gluing, less cutting difficulty after gluing the covering to the support structure, greater possibility of obtaining an extended coupling of the covering to the support structure over time.

Moreover, the weight of the covering element and therefore, of the overall support structure may be minimised using the conventional materials, as more resistant materials integrated to the support structure 10, 100, make the same heavier.

1. Removable protection for a support structure for the human body the support structure having a rear portion, a front portion, a side portion and elements of said support structure, comprising:
a covering element to be applied onto the rear portion and/or onto the front portion and/or onto the side portion of said support structure, said covering element having one or more extensions to fix said covering element to said elements of said support structure and/or to said support structure itself,
wherein said covering element has dimensions suitable for covering at least a part of said rear portion and/or of said front portion and/or of said side portion and a flexibility such as to adapt to their shape.

2. Protection according to claim 1, wherein said covering element is made from a rubber or injected plastic material.

3. Protection according to claim 2, wherein said rubber material has a hardness of 30-80 Shore.

4. Protection according to claim 1, wherein said covering element comprises one or more surface openings, which may or may not pass straight through, able to leave uncovered areas of said underlying rear and/or front and/or side portions.

5. Protection according to claim 1, wherein said one or more extensions are formed integrally with said covering element.

6. Protection according to claim 1, wherein said one or more extensions are elastic.

7. Protection according to claim 1, wherein said one or more extensions comprise reinforcement members.

8. Protection according to claim 1, wherein said one or more extensions end with fastening means, including a hook and/or a tongue equipped with perforations suitable for being fixed, to a coupling element.

9. Protection according to claim 1, wherein said one or more extensions are in the form of two bands with the fastening means attached at their ends.

10. Protection according to claim wherein said coupling element comprises a curved tooth and/or a protuberance and/or a device suitable for engaging with said fastening means.

11. Protection according to claim 10, wherein said coupling means extend from a bracket, fixed to said elements and/or to said support structure.

12. Protection according to claim 11, wherein said bracket has a substantially symmetrical construction and has two semi-cylindrical seats suitable for receiving said elements of said support structure.

13. Protection according to claim 11, wherein said bracket has engagement means suitable for engaging with said elements of said support structure.

14. Protection according to claim 11, wherein said coupling elements extend substantially perpendicularly from said bracket and/or from said support structure.

15. Protection according to claim 1, wherein said one or more extensions have a substantially continuous annular configuration and are joined and/or integral with one another.

16. Support structure for the human body, including a saddle for a bicycle or other similar vehicles, and/or footwear and/or a seat, comprising the removable protection of claim 1.
